(19) United States
(12) Patent Application Publication
(10) Pub. No.: US 2023/0395344 A1
(43) Pub. Date: Dec. 7, 2023

(54) DIELECTRIC-INCREASE CUTOFF DEVICE

(71) Applicant: ARIANEGROUP SAS, Les Mureaux (FR)

(72) Inventors: Frédéric MARLIN, Les Mureaux (FR); Romain LORENZON, Les Mureaux (FR)

(73) Assignee: ARIANEGROUP SAS, Les Mureaux (FR)

(21) Appl. No.: 18/256,828

(22) PCT Filed: Dec. 3, 2021
(86) PCT No.: PCT/FR2021/052210

§ 371 Date: Jun. 9, 2023

(30) Foreign Application Priority Data
Dec. 10, 2020 (FR) 2013018

(51) Int. Cl. H01H 39/00

(52) U.S. Cl. CPC H01H 39/006

(57) ABSTRACT

The invention relates to a cut-off device comprising a conductive element and a movable piston, the piston being able to move between a first position for the passage of the current in the conductive element and a second current cut-off position, the piston being configured to break the conductive element during its passage from its first position to its second position, the piston being positioned in a receiving cavity of a receiving element when said piston is in its second position, the receiving cavity being delimited by at least one inner wall of the receiving element, the inner wall being made of electrically insulating material. The receiving element further comprises fins made of electrically insulating material and extending inside the receiving cavity from said at least one inner wall of the receiving element.

### TECHNICAL FIELD

The present invention relates to the general field of electrical cut-off devices, and more particularly to those of with pyrotechnic triggering.

### PRIOR ART

Some of the pyrotechnic cut-off devices known in the state of the art comprise a body which has a pyrotechnic initiator configured, when triggered, to set in motion a piston provided with a relief in the direction of a conductive bar to be severed.

For example, the document filed under the number FR1908466 which describes a pyrotechnic cut-off device is known. The device presented in the document FR1908466 makes it possible to obtain satisfactory results, in particular for voltages of the intensities ranging up to 18 kA and under voltages on the order of 1 kV. However, the Applicant noticed that the general performance of the device is limited by the level of electrical insulation obtained after the electrical cut-off.

### DISCLOSURE OF THE INVENTION

The invention aims to provide a cut-off device which ensures more reliable and complete electrical insulation, that is to say making it possible to maintain a complete cut-off of the current in a given time which remains short, and a maintenance of a high level of electrical insulation after activation of the cut-off device, the high level of insulation being demonstrated by a leakage current of the order of 10 mA for voltages on the order of 2.5 kV, and/or an electrical insulation resistance greater than 80 MOhm.

To this end, the invention proposes a cut-off device comprising: a conductive element and a movable piston, the piston being able to move between a first position in which the current flows through the conductive element and a second position in which the current is cut-off, the piston being configured to break the conductive element during its translation from its first position to its second position, the piston being positioned in a receiving cavity of a receiving element when said piston is in its second position, the receiving cavity being bounded by at least one inner wall of the receiving element, the inner wall being made of electrically insulating material.

According to one general characteristic of the invention, the receiving element comprises fins made of electrically insulating material and extending inside the receiving cavity protruding from said at least one inner wall of the receiving element.

The presence of portions made of electrically insulating material, such as plastic for example, and extending in protrusion inside the receiving cavity of the body of the cut-off device from an inner wall makes it possible to improve the electrically insulating nature of the cut-off device, and more particularly to promote the maintenance of the electrical cut-off once the cut-off device is actuated.

Firstly, the addition of the fins in the cavity makes it possible first of all to increase the effective surface of insulating material making it possible to dissipate the energy of the plasma generated following the cut-off of the conductive element by the piston, in particular relative to a cylindrical receiving cavity without an inwardly protruding portion.

In other words, the receiving cavity forms a sealed enclosure inside which the plasma of the electric arc is dissipated thanks to the total surface of insulating material within the receiving cavity. The different elements made of insulating material form energy exchange surfaces for dissipating the large amount of energy contained in the electric arc.

Secondly, following the actuation of the cut-off device, an electric arc is produced for a short time. The plasma of the electric arc then deposits soot on the walls of the receiving cavity. Furthermore, the conductive element is cut off into two sections coupled to the rest of the circuit and not electrically connected to each other. These two sections are distant from each other by a distance that depends on the diameter of the piston and on the width of the bar in the case where the piston is circular. The soot deposited on the walls of the receiving cavity can form non-insulating paths which could restore the passage of the current between the two sections of the conductive element.

The presence of the fins in the cavity makes it possible to increase the length of the soot path between the two sections of the severed conductive element and thus to reduce the risk of recovery of an electrical current.

According to a first aspect of the cut-off device, the device preferably comprises at least six fins to maximize the path to be traveled by the soot and to maximize the material making it possible to dissipate the energy of the plasma created during the cut-off while minimizing the mass of the cut-off device.

According to a second aspect of the cut-off device, the fins can comprise a first end secured to said at least one inner wall of the receiving element and a second end which is free inside the receiving cavity, the fins all having the same length between their first end and their second end to maximize the number of fins that can be housed in the receiving cavity while maintaining sufficient distance between the fins.

In one variant, the fins can comprise a first end secured to said at least one inner wall of the receiving element and a second end which is free inside the receiving cavity, the device comprising first fins having a first length between their first end and their second end, and second fins having a second length between their first end and their second end, the second length being smaller than the first length, each first fin being disposed between two second fins and each second fin being disposed between two first fins.

According to a third aspect of the cut-off device, the receiving element can further comprise at least one additional cavity distinct from the receiving cavity and connected to said receiving cavity through at least one channel, said at least one channel being opened when the conductive element is broken by the piston.

Such a cut-off device comprising at least one additional cavity makes it possible to discharge the plasma generated during the breaking of the conductive element towards the additional cavity, thus limiting the amount of plasma in the receiving cavity which tends to slow down the piston and to ensure the electrical continuity between the broken ends of the conductive element.

According to a fourth aspect of the cut-off device, the at least one channel can be obturated by the piston when said piston is in its second position.

According to a fifth aspect of the cut-off device, the at least one channel can be located in line with a breaking point of the conductive element.

According to a sixth aspect of the cut-off device, the receiving element can comprise at least two distinct additional cavities each connected to the receiving cavity by at least one channel.

According to a seventh aspect of the cut-off device, each additional cavity can be connected to the receiving cavity by at least one channel located in line with a breaking point of the conductive element, at least one channel being located in line with each breaking point of the conductive element.

According to an eighth aspect of the cut-off device, said at least one additional cavity can comprise a length at least equal to half the length of the receiving cavity.

According to a ninth aspect of the cut-off device, the volume of said at least one additional cavity can be greater than or equal to the volume of the receiving cavity.

According to a tenth aspect of the cut-off device, said at least one channel can open out into the receiving cavity on a portion of said receiving cavity having a tapered surface of a shape complementary to a portion of the piston.

According to an eleventh aspect of the cut-off device, the device is a pyrotechnic cut-off device comprising a pyrotechnic initiator, the piston being able to move following the actuation of the pyrotechnic initiator between its first position and its second position.

According to a twelfth aspect of the cut-off device, the conductive element can be configured to be broken by the piston at two breaking points.

In one variant, the conductive element is configured to be broken at a breaking point and bent by the piston.

In another object of the invention, there is proposed a secure electrical installation comprising a cut-off device according to any one of the possible characteristics and an electric circuit connected to the conductive element of said device.

In another object of the invention, a vehicle is proposed comprising a secure electrical installation according to any of the possible characteristics.

### BRIEF DESCRIPTION OF THE DRAWINGS

FIG. 1 is a schematic representation of a sectional view of a cut-off device according to a first embodiment of the invention, the piston being in the first position.

FIG. 2 is a schematic representation of a sectional view of the cut-off device of FIG. 1 in which the piston is in the second position.

FIG. 3 is a partial perspective view of the receiving element of the cut-off device of FIG. 1.

FIG. 4 is a perspective view of a receiving element of the cut-off device according to a second possible embodiment of the invention.

FIG. 5 is a schematic representation of a secure electric circuit in which a cut-off device according to the invention is present.

### DESCRIPTION OF THE EMBODIMENTS

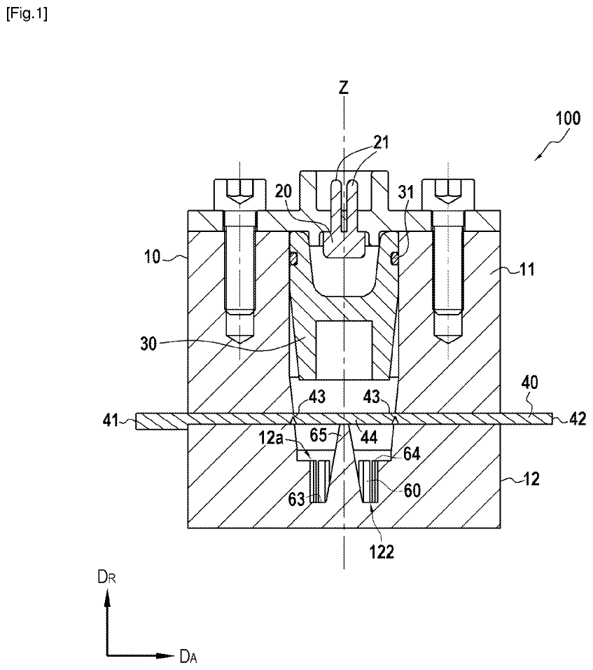

As illustrated in FIGS. 1 and 2, which represent a sectional view of the cut-off device according to one embodiment, a cut-off device 100 according to one embodiment comprises a body 10 inside which a pyrotechnic initiator 20, a piston 30 and a conductive element 40 are installed. The piston 30 is mounted so as to be movable between a first storage position, illustrated in FIG. 1, and a second breaking position, illustrated in FIG. 2, the piston 30 being moved from its first position to its second position by the actuation of the pyrotechnic initiator 20. The piston 30 has the function of breaking the conductive element 40 during its passage from its first position to its second position, thus cutting off the circulation of the electrical current passing through the conductive element 40.

The device 100 comprises a first 41 and a second 42 electric terminal intended to be connected to an electric circuit to be cut off and which correspond here to two ends of the conductive element 40. The conductive element 40 here takes the form of an electrically conductive bar or tab. In one embodiment not illustrated, the device 100 can comprise a plurality of conductive elements. An example of installation comprising an electric circuit connected to the terminals 41 and 42 will be described in relation to FIG. 4.

In order to facilitate the breaking of the conductive element 40 by the piston 30, the conductive element 40 comprises at least one area of weakness 43 which is intended to form a breaking point of the conductive element 40. In the exemplary embodiments illustrated in the figures, the conductive element 40 comprises two areas of weakness 43, thus making it possible to ensure a breakage of the conductive element 40 at two breaking points and to detach a sacrificial portion 44 from the rest of the conductive element 40.

The body 10 can have a cylindrical shape with a main axis Z, as illustrated in the figures, other shapes are however possible. In the embodiment illustrated in FIGS. 1 and 2, the body 10 is formed by a storage element 11 and a receiving element 12 which are assembled together. The storage element 11 has a storage cavity 11 a in which the piston 30 is located when the piston 30 is in its first position. The receiving element 12 has a receiving cavity 12a which is aligned with the storage cavity 11 a and which communicates with said storage cavity 11 a. The receiving cavity 12a is delimited by an inner wall 120 forming an enclosure. The receiving cavity 12a is intended to receive the piston 30 when said piston 30 is in its second position, as illustrated in FIG. 2. The storage cavity 11a and the receiving cavity 12a form a housing in which the piston 30 can move and which is traversed by the conductive portion 44 of the conductive element 40.

The pyrotechnic initiator 20 comprises a pyrotechnic charge connected to connectors 21. The pyrotechnic charge is, when it is initiated for example using a current passing through the connectors 21, able to generate a pressurization gas by its combustion. The conductive elements 21 can be connected to a control device C (FIG. 4) configured to actuate the pyrotechnic initiator 20 when an anomaly is detected.

The piston 30 has, in the embodiment illustrated in FIGS. 1 and 2, a form of revolution about the axis Z. The axis Z corresponds to the axis of movement of the piston 30 and defines an axial direction D_{Z}. The piston 30 comprises a circumferential groove in which a seal 31, for example an O-ring, is housed. The piston 30 can move along a direction of movement along the axis Z inside the body 10 between a high position (first position) as in FIG. 1, and a low position (second position) as in FIG. 2. As long as the pyrotechnic initiator 20 has not been triggered, the piston 30 is in its first position.

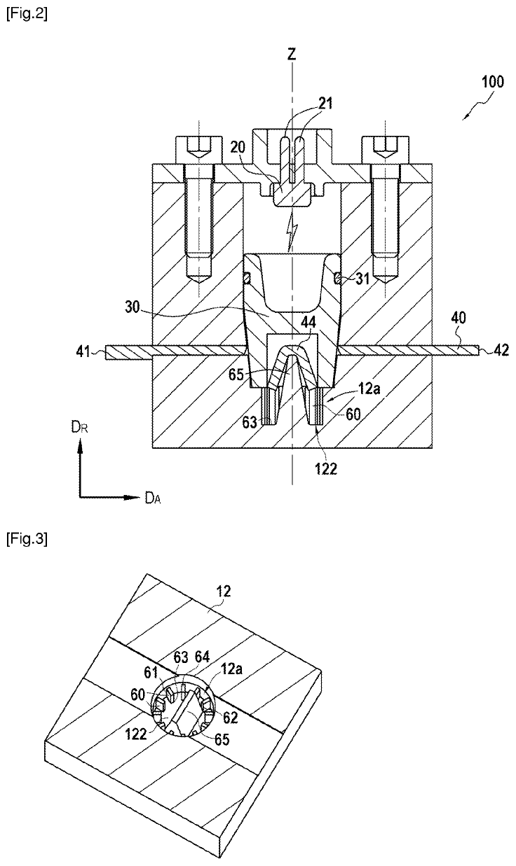

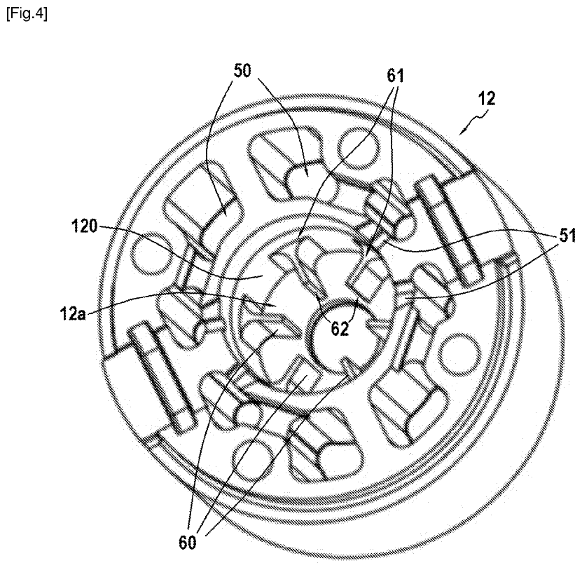

Furthermore, as illustrated in FIGS. 1 and 2, as well as in FIG. 3 which shows a partial perspective view of the receiving element 12 of the cut-off device 100 of FIG. 1, the receiving element 12 of the body 10 of the cut-off device 100 comprises, in the bottom of the receiving cavity 12a, protruding portions 60 extending inside the receiving cavity 12a. The protruding portions 60 form fins. These fins 60 comprise, along a radial direction DR orthogonal to the axial direction D_{Z}, a first end 61 secured to the inner wall 120 and a second free end 62. The fins 60 thus extend, along the radial direction DR, from the inner wall 120 of the receiving element 12 towards the main axis Z. Along the axial direction D_{Z}, the fins 60 comprise a first side 63 secured to a bottom wall 122 of the receiving cavity 12a and a second free side 64 intended to face the piston 30 when the receiving element 12 is assembled with the storage element 11.

Furthermore, the receiving element 12 further comprises a tip 65 extending in protrusion along the axial direction D_{Z} from the bottom wall 122 of the receiving cavity 12a towards the conductive element 40. The tip 65 extends along the axial direction D_{Z} over the entire height of the cavity 12a to bear against a lower face of the conductive element 40 when the receiving element 12 is assembled with the rest of the cut-off device 100 and when the piston 30 is in its first position. The fins 60 extend to the maximum, in the radial direction DR, up to the tip 65.

The piston 30 further comprises on its lower part intended to come into contact with the conductive element 40, a recessed central part along the axial direction D_{Z}. Thus, when the piston 30 passes from its first position, in the storage element 11, to its second position, in the receiving element 12 when the cut-off device 100 is actuated, the piston 30 breaks the conductive element 40 at the level of the two areas of weakness 43, and the broken portion 44, bends around the tip 65, as illustrated in FIG. 2, the piston 30 stopping bearing on the second side 64 of the fins 60 of the receiving element 12.

The fins 60 in the receiving cavity 12a make it possible to increase the effective surface of insulating material able to dissipate the energy of the plasma generated when the conductive element 40 is cut off by the piston 30.

Furthermore, the fins 60 make it possible to increase the length of the soot path between the two cut off sections of the severed conductive element 40 and thus to reduce the risk of recovery of an electrical current at the end of the actuation of the cut-off device 100.

The fins 60 are preferably made of plastic material and can extend along the axial direction D_{Z} only over a portion of the height of the receiving cavity 12a.

FIG. 4 schematically illustrates a perspective view of a receiving element of a cut-off device according to a second embodiment. The second embodiment illustrated in FIG. 4 differs from the first embodiment illustrated in FIGS. 1 to 3 in that, on the one hand, the receiving element 12 does not comprise a tip 65 and, on the other hand, in that the receiving element 12 comprises additional cavities 50 located around the receiving cavity 12a and which are put in communication with said receiving cavity 12a by channels 51. The plurality of additional cavities 50 thus makes it possible to improve the insulation of the plasma bags. In one variant, the receiving element 12 may not comprise any additional cavity.

The additional cavities 50 are cavities distinct from the receiving cavity 12a, in particular the piston 30 does not enter the additional cavities 50 when said piston 30 is positioned in the receiving cavity 12a. The channels 51 which connect the additional cavities 50 to the receiving cavity 12a are open when the piston 30 breaks the conductive element 40, and are obturated by the piston 30 when said piston 30 is in its second position. Such additional cavities 50 make it possible to receive the plasma generated during the breaking of the conductive element 40, the plasma thus being discharged from the receiving cavity 12a towards the additional cavity(ies) 50 by the channel(s) 51. The Applicant has indeed realized that the fact that the plasma stagnates in the receiving cavity 12a tends on the one hand to slow down the motion of the piston 30, and on the other hand tends to allow the circulation of the electrical current despite the breaking of the conductive element 40. The fact of moving the plasma out of the receiving cavity 12a thus allows the device 100 to more quickly and more effectively cut off the circulation of an electrical current between the two terminals 41 and 42 of the conductive element, 40 and this despite the fact that the voltage and the intensity of the electrical current are high (in particular a voltage greater than 500 V and an intensity greater than 10 kA) and cause the generation of plasma during the breaking of the conductive element 40.

Once the conductive element 40 is broken, the piston 30 can then obturate the channel(s) 51, thus maintaining the plasma in the additional cavities 50, which thus limits the risk that the current continues to circulate despite the cut-off of the conductive element 40.

In FIG. 4, the channels 51 are located at the level of the face of the receiving element 12 intended to be in contact with the conductive element 40, in other words, in line with a breaking point of the conductive element 40. This allows a better discharge of the plasma towards the additional cavity(ies) 50. Indeed, the plasma is generated at the level of the breaking point of the conductive element 40.

In one variant, the channels 51 can be located close to a breaking point of the conductive element 40, that is to say at a distance less than or equal to 5 mm from a breaking point of the conductive element 40.

In order to minimize the amount of plasma remaining in the receiving cavity 12a, the size of the additional cavity(ies) 50 is advantageously large enough relative to the size of the receiving cavity 12a. Thus, the additional cavity(ies) 50 have a length which is at least equal to the length of the receiving cavity 12a. Even more advantageously, the total volume of the additional cavity(ies) 50 is greater than or equal to the volume of the receiving cavity 12a. Preferably, the total volume of the additional cavity(ies) 50 is greater than the volume of the receiving cavity 12a.

In the second embodiment illustrated in FIG. 4, the channels 51 open out into the receiving cavity 12a on a portion of said receiving cavity 12a which has a tapered surface. The shape of the tapered surface of the portion of the receiving cavity 12a is complementary to the shape of a portion of the piston 30, thus making it possible to improve the sealing of the closure of the channels 51 by the piston 30.

In one variant, the channels 51 can be located in a lower part of the receiving cavity 12a.

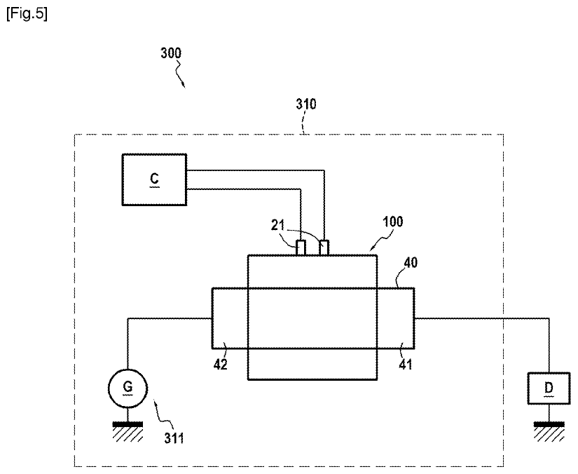

FIG. 5 schematically shows an example of a secure electrical installation 300 implementing the cut-off device 100 according to the invention.

The secure electrical installation 300 comprises a secure power supply system 310 comprising the cut-off device 100 (represented very schematically) and a power supply circuit 311. The power supply circuit 311 here comprises an electric generator G connected to the second terminal 42 of the conductive portion 40 of the cut-off device 100. The electric generator G can be for example a battery or an alternator.

The secure power supply system 310 further comprises a control element C configured to actuate the pyrotechnic initiator 20 when an anomaly is detected. The control element C is connected to the pyrotechnic initiator 20 through the connectors 21. The anomaly in response to which the control element C can trigger the pyrotechnic initiator 20 can be an electrical anomaly, such as a crossing of current threshold in the circuit, or a non-electrical anomaly such as the detection of a shock, for example a sudden deceleration of the control element, a change in temperature, pressure, etc. In the event of detection of an anomaly, the control element C is able to send an electrical current to the pyrotechnic initiator 20 for its triggering in order to cut off the current, as described above.

The secure electrical installation 300 finally comprises an electric device D connected here to the first terminal 41 of the conductive portion 40 of the cut-off device 100 to be powered by the secure power supply system 310.

For example, a motor vehicle can comprise a secure electrical installation 300.

1. A cut-off device comprising a conductive element and a movable piston, the piston being able to move along an axial direction between a first position in which the current flows through the conductive element and a second position in which the current is cut-off, the piston being configured to break the conductive element during its translation from its first position to its second position, and the piston being positioned in a receiving cavity of a receiving element when said piston is in its second position, the receiving cavity being bounded by at least one inner wall of the receiving element forming an enclosure, the inner wall being made of electrically insulating material, that wherein the receiving element comprises fins made of electrically insulating material and extending inside the receiving cavity from said at least one inner wall of the receiving element, the fins extending, along a direction perpendicular to said axial direction, between a first end secured to the inner wall and a second end which is free, and comprising, along the axial direction, a first side secured to a bottom wall of the receiving cavity and a second side which is free and on which the piston is bearing when it is in its second position.

2. The device according to claim 1, comprising at least six fins.

3. The device according to claim 1, wherein the fins comprise a first end secured to said at least one inner wall of the receiving element and a second end which is free inside the receiving cavity, the fins all having the same length between their first end and their second end.

4. The device according to claim 1, wherein the fins comprise a first end secured to said at least one inner wall of the receiving element and a second end which is free inside the receiving cavity, the device comprising first fins having a first length between their first end and their second end, and second fins having a second length between their first end and their second end, the second length being smaller than the first length, each first fin being disposed between two second fins and each second fin being disposed between two first fins.

5. The device according to claim 1, wherein the receiving element further comprises at least one additional cavity distinct from the receiving cavity and connected to said receiving cavity through at least one channel, said at least one channel being opened when the conductive element is broken by the piston.

6. The device according to claim 5, wherein said at least one channel is obturated by the piston when said piston is in its second position.

7. The device according to claim 5, wherein said at least one channel is located in line with a breaking point of the conductive element.

8. The device according to claim 5, wherein the receiving element comprises at least two distinct additional cavities each connected to the receiving cavity by at least one channel.

9. The device according to claim 5, wherein each additional cavity is connected to the receiving cavity by at least one channel located in line with a breaking point of the conductive element, at least one channel being located in line with each breaking point of the conductive element.

10. The device according to claim 5, wherein said at least one additional cavity comprises a length at least equal to half the length of the receiving cavity.

11. The device according to claim 5, wherein the volume of said at least one additional cavity is greater than or equal to the volume of the receiving cavity.

12. The device according to claim 5, wherein said at least one channel opens out into the receiving cavity on a portion of said receiving cavity having a tapered surface of a shape complementary to a portion of the piston.

13. The device according to claim 1, wherein the device is a pyrotechnic cut-off device comprising a pyrotechnic initiator, the piston being able to move following the actuation of the pyrotechnic initiator between its first position and its second position.

14. The device according to claim 1, wherein the conductive element is configured to be broken by the piston at two breaking points.

15. The device according to claim 1, wherein the conductive element is configured to be broken at a breaking point and bent by the piston.

16. A secure electrical installation comprising a cut-off device according to claim 1 and an electric circuit connected to the conductive element of said device.

17. A vehicle comprising a secure electrical installation according to claim 16.
